(19) United States
(12) Patent Application Publication
(10) Pub. No.: US 2009/0080760 A1
(43) Pub. Date: Mar. 26, 2009

(54) ANTI-COUNTERFEITING MARK AND METHODS

(75) Inventors: Andriy Knysh, Boca Raton, FL (US); Derek Goetz, Surfside, FL (US); Aleksandr Kruchakov, Aventura, FL (US); Ruvin Kantarzhi, Brooklyn, NY (US); Nikolai Krivoruchko, Kharkov Region (UA); Alexey Moshkov, Boynton Beach, FL (US); Nikolay Shturkin, Yekaterinburg (RU)

Correspondence Address: HOWARD & HOWARD ATTORNEYS PLLC, 450 West Fourth Street, Royal Oak, MI, 48067, US

(73) Assignee: MICROSECURITY LAB INC., Boca Raton, FL (US)

(21) Appl. No.: 12/234,686

(22) Filed: Sep. 21, 2008

Related U.S. Application Data
(60) Provisional application No. 60/994,762, filed on Sep. 21, 2007.

(51) Int. Cl. G06K 9/00

(52) U.S. Cl. 382/141

(57) ABSTRACT

An anti-counterfeiting mark is formed on a surface of an object, preferably by engraving with a laser at the point of manufacture. The mark includes a padlock symbol visible to a person without magnification for informing the person that anti-counterfeiting techniques are in use. The mark also includes a microscopic pattern. Preferably, the microscopic pattern is varied from object to object for uniqueness. The microscopic pattern must be magnified to properly discern its intricacies. The mark further includes a bar code containing data relating to the microscopic pattern. The microscopic pattern may be compared against the data stored by the bar code to verify authenticity.

### CROSS REFERENCE TO RELATED APPLICATION

This application claims the benefit of U.S. Provisional Application No. 60/994,762 filed Sep. 21, 2007, which is incorporated by reference.

### BACKGROUND OF THE INVENTION

1. Field of the Invention

The subject invention relates generally to anti-counterfeiting techniques. Specifically, the subject invention relates to an anti-counterfeiting mark formed on a surface of an object and a method for utilizing an anti-counterfeiting mark.

2. Description of the Related Art

Counterfeiting is a global problem that affects all legitimate business in all industries in all countries. Counterfeit and pirated goods result in hundreds of billions of dollars per year in costs to brand owners worldwide as well as the accompanying loss of legitimate jobs. These counterfeit goods are often of substandard quality, which results in safety risks. Furthermore, counterfeiting also has a close inter-relationship with organized crime, with all its other societal consequences.

A wide variety of techniques for protection of objects from counterfeiting and unauthorized reproduction by means of marking or labeling them with special marks are known in the prior art. Those techniques include 1D and 2D barcodes, radio frequency identification (RFID) tags, high capacity color barcodes (HCCB), holograms and holographic barcodes, generic chemical taggants, chemical barcodes, chipless radio frequency (RF) taggants and barcodes, UV and IR fibers, magnetic threads and barcodes, color-shifting and invisible inks, watermarks, latent images, and security micro printing.

Each of these techniques may have their advantages and disadvantages. However, there remains an opportunity to provide an anti-counterfeiting mark that is both durable and extremely difficult to copy.

### SUMMARY OF THE INVENTION AND ADVANTAGES

The subject invention provides an anti-counterfeiting mark formed on a surface of an object. The mark includes an overt portion visible to a person without magnification for informing the person that anti-counterfeiting techniques are in use. The mark also includes a covert portion having a microscopic pattern examinable to a discernable level of resolution only with magnification.

The subject invention also provides a method for utilizing an anti-counterfeiting mark. The method includes the step of forming a microscopic pattern on a surface of an object. The microscopic pattern is examinable to a discernable level only with magnification. The method also includes the step of magnifying and electronically scanning the microscopic pattern at a first location. First identification data corresponding to the microscopic pattern is resolved in response to the electronic scanning of the microscopic pattern at the first location. The method also includes the step of storing the first identification data at the first location such that it may be read at a second location. The method further includes the step of magnifying and electronically scanning the microscopic pattern at the second location. In response, the second identification data corresponding to the microscopic pattern is resolved. The first identification data is read at the second location. The method also includes the step of comparing the second identification data to the first identification data to determine if the object is genuine or counterfeit.

The mark and method of the subject invention provide excellent durability and anti-counterfeiting protection. Specifically, by forming the mark in the surface of an object, the mark becomes an integral part of the object in comparison to an easily replaceable label. Furthermore, the covert portion of the mark is near impossible to copy without magnification.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an object bearing a anti-counterfeiting mark of the subject invention;

FIG. 2 is a magnified view of the anti-counterfeiting mark formed on a surface of an object;

FIG. 3 is a magnified view of a microscopic pattern of one embodiment of the anti-counterfeiting mark implemented as a series of holes forming a generally straight line with respect to an axis;

FIG. 4 is a magnified view of the microscopic pattern of one embodiment of the anti-counterfeiting mark implemented as a continuous channel forming a generally straight line with respect to the axis;

FIG. 5 is a magnified view of the microscopic pattern of one embodiment of the anti-counterfeiting mark implemented as a series of holes forming a non-straight line which varies with respect to the axis;

FIG. 6 is a magnified view of the microscopic pattern of one embodiment of the anti-counterfeiting mark implemented as a continuous channel forming a non-straight line which varies with respect to the axis;

FIG. 7 is a magnified view of the microscopic pattern of one embodiment of the anti-counterfeiting mark implemented as a figure eight shape without variations;

FIG. 8 is a magnified view of the microscopic pattern of one embodiment of the anti-counterfeiting mark implemented as a figure eight shape with variations;

FIG. 9 is a magnified view of the microscopic pattern of one embodiment of the anti-counterfeiting mark implemented as a figure eight shape with variations and showing markers realized during magnified scanning of the microscopic pattern;

FIG. 10 is a magnified view of a reproduction of the microscopic pattern of one embodiment of the anti-counterfeiting mark implemented as a figure eight shape with variations and showing markers that identify a forgery;

FIG. 11 is a flowchart diagram of a method of utilizing the anti-counterfeiting mark; and

FIG. 12 is a block diagram of an exemplary system for implemented the method of utilizing the anti-counterfeiting mark.

### DETAILED DESCRIPTION OF THE INVENTION

Referring to the Figures, wherein like numerals indicate corresponding parts throughout the several views, an anti-counterfeiting mark is shown at 10.

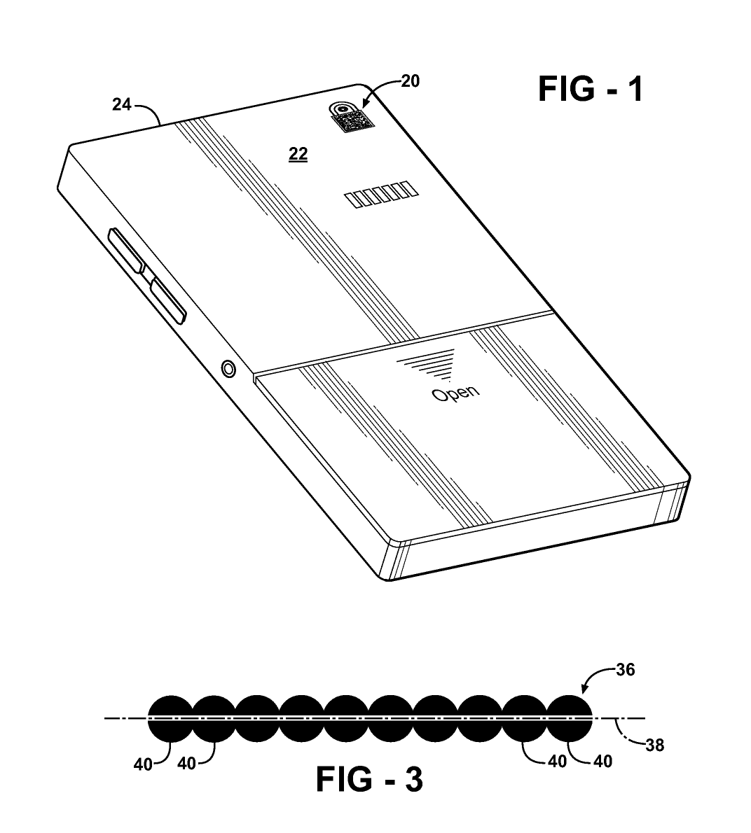

Referring to FIG. 1, the anti-counterfeiting mark 20 is formed on a surface 22 of an object 24. The object 24 may be any item for which anti-counterfeiting measures are desired to prevent unauthorized copying, forgeries, etc. Preferably, the mark 20 is utilized on a plurality of objects 24 that are being manufactured. However, for purposes of clarity, the plurality of objects 24 will be referred to hereafter as a singular object 24.

As stated above, the mark 20 is formed in the surface 22 of the object 24. Said another way, the mark 20 consists of grooves, channels, holes, and other such voids formed in the surface 22 of the object 24. By forming the mark 20 into the surface, the mark 20 is permanent, durable, and provides high resistance to various environmental factors and is therefore suitable for life-time use with the object 24. Accordingly, the object 24 includes a sufficiently substantial region (not numbered) to accommodate the formation of the mark 20 on the surface 22. The mark 20 may be formed on various surfaces 22 formed of various materials, including, but not limited to, metals and plastics.

The mark 20 is preferably formed by inscribing on the surface 22 with a laser 25. Inscribing the mark 20 utilizing the laser results in a very permanent durable solution that exhibits a high resistance to temperatures, chemicals, distortion, abrasion, corrosion, or tampering. Although utilization of the laser is preferred, other techniques for forming the mark 20 are also acceptable, including, but not limited to, chemical or mechanical etching.

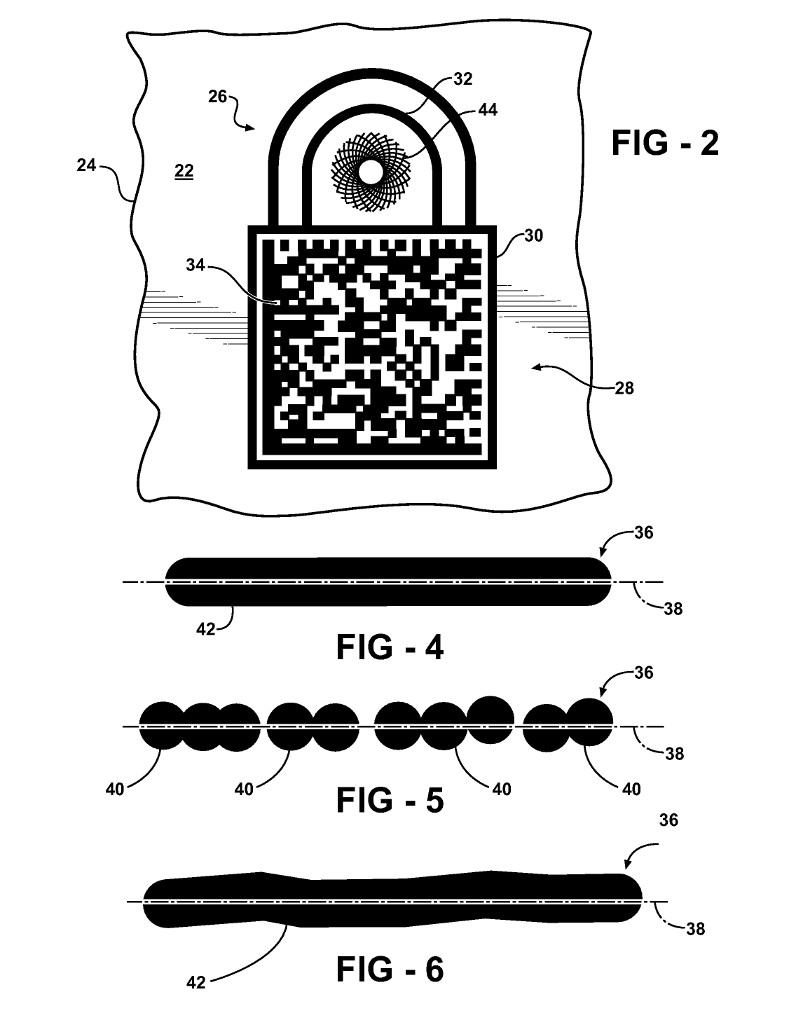

Referring now to FIG. 2, the mark 20 includes an overt portion 26 and a covert portion (not numbered). The overt portion 26 is visible to a person without magnification. That is, the overt portion 26 is visible to a normal sighted individual with the naked eye. The covert portion is generally not visible to a person without magnification in any meaningful way. That is, a normal sighted individual would either not notice the covert portion at all or would not be able to distinguish the covert portion from the overt portion 26.

In the illustrated embodiment, the overt portion 26 includes a symbol 28. The symbol 28 serves to inform persons, such as users of the object 24 and potential counterfeiters, that anti-counterfeiting techniques are in use. Said another way, the symbol 28 signals that the mark 20 and the object 24 carrying the mark 20 are protected. Preferably, and as shown in the illustrated embodiment, the symbol 28 is shaped like a padlock (not numbered). The padlock-shaped symbol 28 preferably includes a rectangular section 30 having a rectangular or square shape and a pair of semi-circular sections 32 having semi-circular shapes extending to and from one side of the rectangular section 30.

The overt portion 26 of the illustrated embodiment also includes a data storage pattern 34 for storing data. The data storage pattern 34 is readable by a person and/or a machine. Preferably, the data storage pattern 34 is a barcode disposed within the rectangular section 30. However, those skilled in the art realize other techniques other than the barcode to implement the data storage pattern 34 as well as other locations to position the data storage pattern 34.

The barcode may be implemented using any suitable barcode technique as is realized by those skilled in the art. For example, the barcode may be implemented as a standard one-dimensional barcode, a standard two-dimensional barcode (such as a DataMatrix barcode, a QR code, or a PDF417 barcode), or a spread spectrum barcode. However, other barcodes may alternatively be implemented.

Referring to FIGS. 4-10, the covert portion of the mark 20 includes at least one microscopic pattern 36. The mark 20 may include a single microscopic pattern 36 or a plurality of microscopic patterns 36. For purposes of descriptive clarity, the single microscopic pattern 36 will be generally discussed below. Nevertheless, the plurality of microscopic patterns 36 may be implemented.

As with the entire mark 20, the microscopic pattern 36 is preferably formed by inscribing on the surface 22 with the laser, thus generating a void or channel (not numbered). Use of the laser allows for the ultra-fine resolution required to form the microscopic pattern 36. The microscopic pattern 36 may be disposed at various locations in and around the mark 20 including within the symbol 28 and/or within the data storage pattern 34. Those skilled in the art realize other suitable locations for disposition of the microscopic pattern 36.

The microscopic pattern 36 is microscopic in nature and is examinable to a discernable level of resolution only with magnification. The term “discernable level” refers to an amount of magnification that allows key features of the microscopic pattern 36 to be recognized, e.g., the depth, width, and position of the void at various points in order to decode data from the mark 20. Said another way, one is unable to properly decipher the details of the microscopic pattern 36 that are necessary to properly utilize the mark 20 without magnification.

Preferably, the microscopic pattern 36 on the surface 22 of a first object (not numbered) will be different from the microscopic pattern 36 on the surface 22 of a second object (not numbered). Said another way, the microscopic pattern 36 is preferably unique for the object 24 on which it is formed. The uniqueness of the microscopic pattern 36 for the particular object 24 on which it is formed is used to positively identify the object 24 and show that the object 24 is genuine and not a counterfeit copy.

Once magnified, the microscopic pattern 36 is imaged in at least two dimensions. Said another way, the microscopic pattern 36 is scanned, digitized, and encoded, i.e., turned into numerical data. Preferably, the microscopic pattern 36 is imaged in three dimensions such that the lengths, widths, and depths of the microscopic pattern 36 may be assessed. This encoding of the microscopic pattern 36 yields identification data that may be stored and used to verify the authenticity of the object 24 bearing the mark 20 at a later time. The authenticity of the object 24 may also be verified at a second location 50 remote from a first location 48. The identification data may also be encrypted using one of the techniques known to those skilled in the art, including, but not limited to, an asymmetric public-private key cryptography technique.

The identification data may be stored as part of the data storage pattern 34, i.e., the data storage pattern 34 includes identification data corresponding to the microscopic pattern 36. The identification data may also be stored in a computerized database (not shown). Furthermore, the identification data may be stored both as part of the data storage pattern 34 and in the computerized database. Other techniques for storing the identification data are realizable to those skilled in the art.

The microscopic pattern 36 may also employ redundant characteristics such that the identification data may be repeatedly encoded in the microscopic pattern 36. Accordingly, the identification data is available from the microscopic pattern 36 even if a portion of the microscopic pattern 36 is unavailable due to damage to the mark 20 or other irregularities.

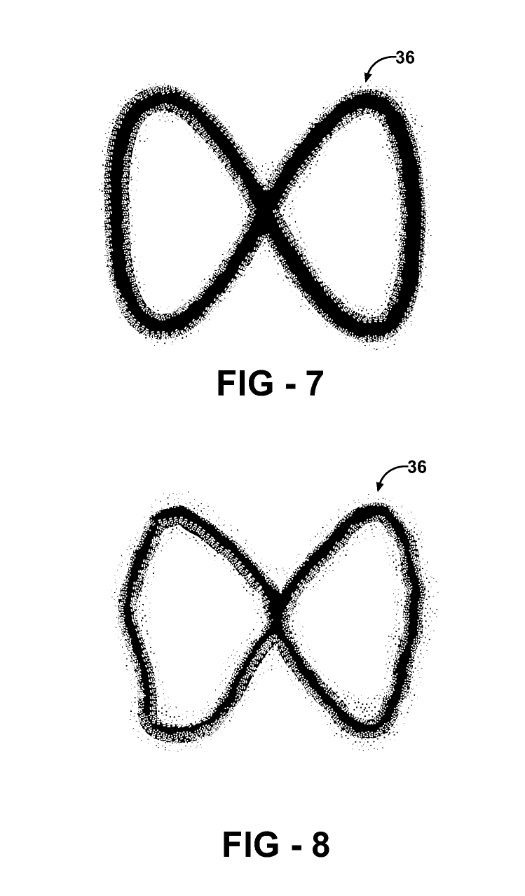

The microscopic pattern 36 may be implemented in any of a number of shapes. For example, as shown in FIGS. 3-6, the microscopic pattern 36 may be implemented as a line. That is, the microscopic pattern 36 is generally straight with respect to a linear axis 38. As another example, as shown in FIGS. 7-10, the microscopic pattern 36 may be implemented as a “figure eight” shape. Of course, those skilled in the art realize other shapes to implement the microscopic pattern 36, including, but not limited to, polygons, circles, squares, triangles, etc. Furthermore, the microscopic pattern 36 may be implemented with a combination of different shapes that are connected together or separated apart.

The shape of the microscopic pattern 36 may be formed using a variety of procedures. As shown in FIG. 3, the line shape is produced by the laser generating a series of circular holes 40 disposed adjacent one another. As shown in FIG. 4, the line shape is produced by moving the laser beam to generate a continuous channel 42.

Preferably, the microscopic pattern 36 is varied from object to object for enhancing the uniqueness described above. The variation is preferably based on a random algorithm or pseudo-random algorithm. However, the variation may also be predetermined for each object based on some predetermined criteria.

Numerous techniques may be utilized to vary the microscopic pattern 36. In one technique, the microscopic pattern 36 is varied by varying its coordinates; that is, moving the laser beam generated by the laser away from a standard shape or path. An example of this technique is shown in FIGS. 5 and 6, in which the coordinates of the line shapes of FIGS. 3 and 4 are varied to provide a shape that is non-linear with respect to the linear axis 38.

In another technique, the microscopic pattern 36 is varied by modulating an aspect of the laser and/or a laser beam generated by the laser. These aspects include, but are not limited to, power of the laser, focus of the laser beam, profile (size, width, etc.) of the laser beam, frequency, speed and/or acceleration of the laser beam, duration of a laser pulse, duty cycle of the laser, mark and jump delays of the laser, ON and OFF delays of the laser, and poly-line marking delays of the laser. Those skilled in the art will realize other modifiable aspects of the laser.

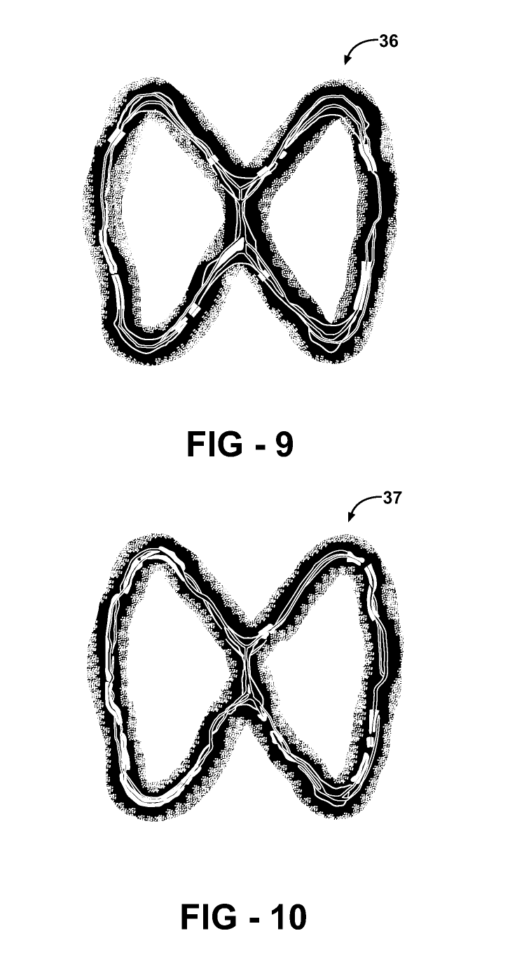

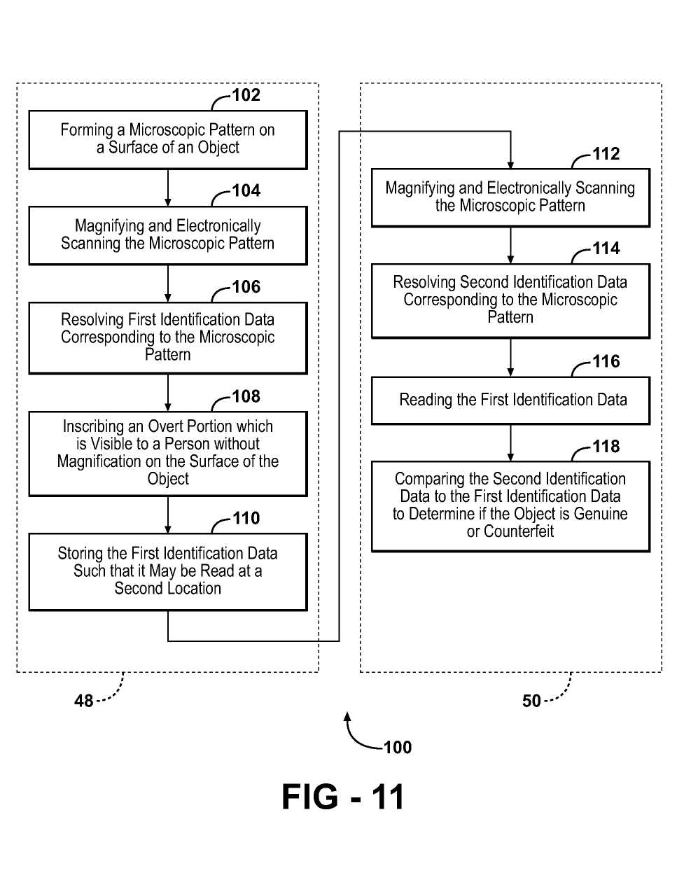

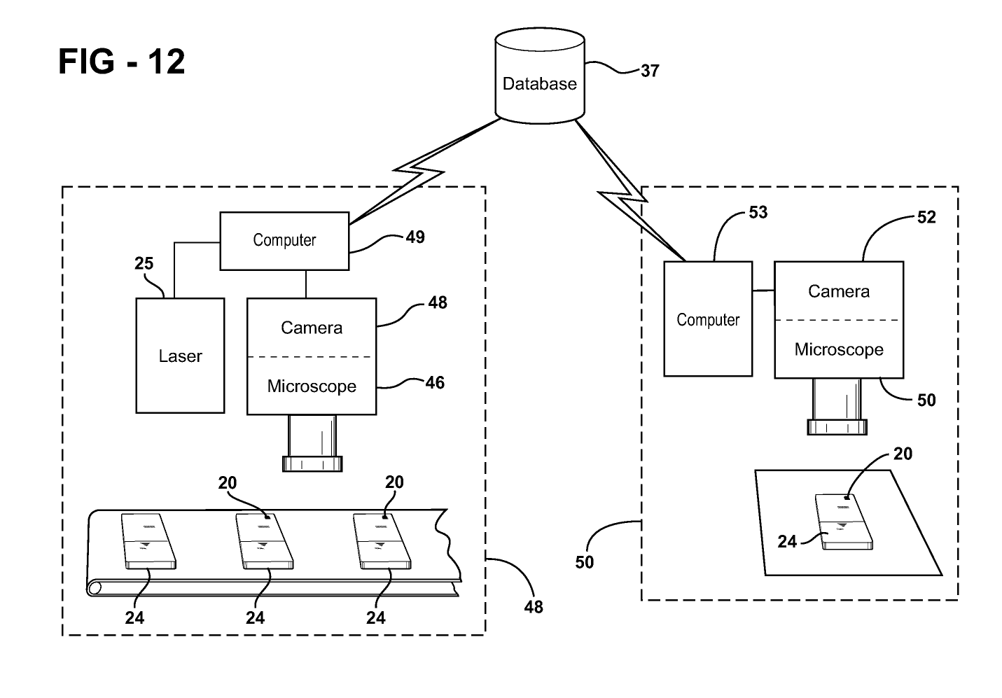

Microscopic patterns 38 without variation are less difficult to duplicate than microscopic pattern 36 with variation. Therefore, microscopic patterns 38 without variation are more susceptible to reproduction using standard pixel-by-pixel scanning techniques. An example of this is shown by comparing a microscopic pattern 36 with variation, as shown in FIG. 9, to a reproduction of that pattern, as shown in FIG. 10. As can be seen, the standard pixel-by-pixel scanning technique introduces error into the pattern. This error results in a different identification data being produced, which, in turn, results in the identification of a counterfeit object 24.

Referring again to FIG. 2, the overt portion 26 of the mark 20 may also include a visible pattern 44. In the illustrated embodiment, the visible pattern 44 is implemented as a hypotrochoid-like curve (not numbered). However, other suitable curves and images may be implemented as recognized by those skilled in the art. Also in the illustrated embodiment, the visible pattern 44 is disposed in a space (not numbered) between the semi-circular sections 32 and the rectangular section 30. Of course, other suitable locations for the visible pattern 44 are contemplated by those skilled in the art.

Preferably, the visible pattern 44 is varied from one object 24 to the next for enhancing the uniqueness of the mark 20. As with the microscopic pattern 36, the variation of the visible pattern 44 is preferably based on a random algorithm or pseudo-random algorithm and performed with those techniques described above.

The visible pattern 44 may be used to further provide identification data. This identification data may match or differ from the identification data provided by the microscopic pattern 36. The identification data may also be stored in the database or in the data storage pattern 34.

The subject invention also provides a method 100 for producing and utilizing an anti-counterfeiting mark 20. The method 100 is presented hereafter in terms of the mark 20 described above. However, those skilled in the art realize that other such marks 20 may be contemplated that can be utilized by the method 100. Therefore, the disclosure of the method 100 should not be read as limited only to the aforementioned mark 20.

The method 100 preferably includes the step 102 of inscribing an overt portion that is visible to a person without magnification on the surface of the object. As described above, this overt portion communicates to a user that security protection is in effect. The overt portion preferably includes a data storage pattern for storing data. The data storage pattern, as described above, may be implemented as a bar code.

The method 100 includes the step 104 of forming a microscopic pattern on a surface of an object. The microscopic pattern is examinable to a discernable level only with magnification. The forming of the microscopic pattern is preferably preformed by inscribing with a laser; but as stated above, other techniques for forming the microscopic pattern may alternatively be utilized.

The method 100 further includes the step 106 of magnifying and electronically scanning the microscopic pattern at a first location. The magnification of the microscopic pattern is preferably performed using a microscope and more preferably using a zoom microscope. However, other techniques for magnifying the microscopic pattern are realized by those skilled in the art. Scanning of the microscopic pattern is aided by use of an industrial digital camera in communication with a computer. Numerous suitable industrial cameras are acceptable, including, but not limited to the 6.6 megapixel Lw625 and the 10.7 megapixel Lw 1059 manufactured by Lumenera Corporation of Ottawa, Ontario, Canada.

In response to the electronic scanning of the microscopic pattern at the first location, the method further includes the step 108 of resolving first identification data corresponding to the microscopic pattern. That is, the first identification data is determined based on the features of the microscopic pattern, including, but not limited to the position, depth, and width of the channel or channels of the microscopic pattern.

The method also includes the step 110 of storing the first identification data such that it may be read at a second location. There are numerous techniques for storing the first identification data. In one technique, the first identification data may be encoded into the data storage pattern. Thus, the mark carries the first identification data. In another technique, the first identification data is written to a computerized database. Of course, multiple techniques for storing the first identification data may be performed for each mark.

The method 100 further includes the step 112 of magnifying and electronically scanning the microscopic pattern at the second location. This step may be performed using a microscope and industrial digital camera as described above or by utilizing other techniques known to those skilled in the art.

In response to electronically scanning the microscopic pattern at the second location, the method 100 continues with the step 114 of resolving second identification data corresponding to the microscopic pattern.

The method 100 further includes the step 116 of reading the first identification data at the second location. This step may be performed by decoding the data storage pattern, receiving the first identification data from the computerized database, or other techniques known to those skilled in the art.

The method continues with the step 118 of comparing the second identification data to the first identification data to determine if the object is genuine or counterfeit. If the first identification data, which was determined after scanning at the first location, substantially matches the second identification data, which was determined at the second location, then the object is likely genuine. If the first and second identification data do not substantially match one another, then the object is likely counterfeit.

Of course, there may be some minor differences between the sets of identification data, even in genuine objects. For instance, the magnification and scanning equipment at each location is different, which may skew results. Furthermore, some damage to the microscopic pattern may have occurred while the object is shipped, i.e., moved between locations. Other reasons for differences between the sets of identification data are realized by those skilled in the art.

Preferably, the first location is a facility where the mark is initially applied to the object. More preferably, the first location is the manufacturing facility where the object is first created. The second location is somewhere distant from the first location. For example, the second location may be a receiving dock or a distribution warehouse. Of course, those skilled in the art will realize numerous other possibilities for the first and second locations.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. An anti-counterfeiting mark formed on a surface of an object, said mark comprising:
an overt portion visible to a person without magnification for informing the person that anti-counterfeiting techniques are in use; and
a covert portion having a microscopic pattern examinable to a discernable level of resolution only with magnification.

2. An anti-counterfeiting mark as set forth in claim 1 wherein said overt portion includes a symbol shaped like a padlock.

3. An anti-counterfeiting mark as set forth in claim 1 wherein said overt portion includes a data storage pattern for storing data that is readable by a person and/or a machine.

4. An anti-counterfeiting mark as set forth in claim 3 wherein said data storage pattern is further defined as a barcode.

5. An anti-counterfeiting mark as set forth in claim 4 wherein said data storage pattern includes identification data corresponding to an arrangement of said microscopic pattern.

6. An anti-counterfeiting mark as set forth in claim 5 wherein said arrangement of said microscopic pattern is redundant such that said identification data corresponding is available if a portion of said microscopic pattern is unavailable.

7. An anti-counterfeiting mark as set forth in claim 1 wherein an arrangement of said microscopic pattern is varied based on at least one of a random algorithm or pseudo-random algorithm.

8. An anti-counterfeiting mark as set forth in claim 1 wherein said microscopic pattern is inscribed in the surface using a laser.

9. An anti-counterfeiting mark as set forth in claim 8 wherein at least a part of said microscopic pattern is varied by varying coordinates of an arrangement of the microscopic pattern produced by the laser.

10. An anti-counterfeiting mark as set forth in claim 8 wherein at least a part of said microscopic pattern is varied by modulating an aspect of the laser.

11. A method for utilizing an anti-counterfeiting mark, said method comprising the steps of:
forming a microscopic pattern on a surface of an object which is examinable to a discernable level only with magnification;
magnifying and electronically scanning the microscopic pattern at a first location;
resolving first identification data corresponding to the microscopic pattern in response to electronically scanning the microscopic pattern at the first location;
storing the first identification data such that the first identification data may be read at a second location;
magnifying and electronically scanning the microscopic pattern at the second location;
resolving second identification data corresponding to the microscopic pattern in response to electronically scanning the microscopic pattern at a second location;
reading the first identification data at the second location;
comparing the second identification data to the first identification data to determine if the object is genuine or counterfeit.

12. A method as set forth in claim 11 wherein said step of forming a microscopic pattern is further defined as inscribing the microscopic pattern using a laser.

13. A method as set forth in claim 11 further comprising the steps of inscribing an overt portion of the anti-counterfeiting mark which is visible to a person without magnification on the surface of the object.

14. A method as set forth in claim 11 wherein overt portion includes a data storage pattern and said step of storing the first identification data includes the step of encoding the first identification data in the data storage pattern.

15. A method as set forth in claim 11 wherein said step of storing the first identification data includes the step of writing the first identification data to a computerized database.

16. An anti-counterfeiting mark formed on a surface of an object, said mark comprising:
a symbol shaped like a padlock and visible to a person without magnification for informing the person that anti-counterfeiting techniques are in use;
a first microscopic pattern examinable to a certain level of resolution only with magnification; and
a bar code for storing data disposed within said symbol for storing data that is readable by a person and/or a machine.

17. An anti-counterfeiting mark as set forth in claim 16 further comprising a security signature being visible to a person without magnification and including a second microscopic pattern examinable to a certain level of resolution only with magnification.

18. An anti-counterfeiting mark as set forth in claim 16 wherein said bar code includes identification data corresponding to an arrangement of said first microscopic pattern.

19. An anti-counterfeiting mark as set forth in claim 16 wherein an arrangement of said first microscopic pattern is varied based on at least one of a random algorithm or pseudo-random algorithm.

20. An anti-counterfeiting mark as set forth in claim 16 wherein said first microscopic pattern is inscribed in the surface using a laser.
